(19) United States
(12) Patent Application Publication
(10) Pub. No.: US 2020/0151687 A1
(43) Pub. Date: May 14, 2020

(54) Method, System, and Computer Program Product for Processing a Cash Transaction

(71) Applicant: Visa International Service Association, San Francisco, CA (US)

(72) Inventor: Gurpreet Singh Bhasin, Fremont, CA (US)

(21) Appl. No.: 16/185,162

(22) Filed: Nov. 9, 2018

(51) Int. Cl. G06Q 20/10; G06Q 20/32; G06Q 20/24

(52) U.S. Cl. CPC G06Q 20/102; G06Q 20/24; G06Q 20/322

(57) ABSTRACT

A computer-implemented method for processing a transaction initiated using cash includes: determining a transaction amount; determining an amount of cash received from the user; determining an amount of change due to the user; receiving an identifier associated with the user; generating a credit message identifying the amount of change due and the identifier; and communicating the credit message to a remote system configured to credit the amount of change due to a user account corresponding to the identifier. A system and computer program product for processing a transaction initiated using cash are also disclosed.

### BACKGROUND OF THE INVENTION

### Field of the Invention

This invention relates to processing cash-based payment transactions and, in one non-limiting embodiment, to a computer-implemented method, system, and computer program product for processing a payment transaction initiated using cash.

### Description of Related Art

Payment transactions initiated using credit or debit cards have become ubiquitous. In fact, due to the convenience associated with transactions initiated using credit or debit cards, both for merchants and for consumers, many merchants have stopped accepting cash as a form of payment. For example, the inconveniences associated with giving change back to the consumer and security concerns associated with handling cash are among the reasons merchants are moving away from accepting cash payments.

However, for various reasons, some consumers do not have any credit or debit cards and rely on their cash being accepted by the merchant in order to initiate their payment transactions. Thus, these consumers may be precluded from initiating transactions at merchants who no longer accept cash payments, negatively affecting both the consumers and the merchants.

### SUMMARY OF THE INVENTION

Accordingly, and generally, provided is an improved computer-implemented method, system, and computer program product for processing a transaction initiated using cash.

According to a non-limiting embodiment or aspect, provided is a computer-implemented method for processing a transaction initiated using cash including: determining, with at least one processor of a merchant system, a transaction amount associated with a payment transaction between a user and a merchant; determining, with the at least one processor, an amount of cash received from the user associated with the payment transaction; in response determining that the amount of cash received exceeds the transaction amount, determining, with the at least one processor, an amount of change due to the user; receiving, with the at least one processor, an identifier associated with the user; in response to determining the amount of change due, generating, with the at least one processor, a credit message identifying the amount of change due and the identifier; and communicating, with the at least one processor, the credit message to a remote system configured to credit the amount of change due to a user account corresponding to the identifier.

In one non-limiting embodiment or aspect, the method may further include: in response to the user initiating a second payment transaction having a second transaction amount, applying, with at least one processor, at least a portion of the amount of change due credited to the user account corresponding to the identifier toward the second transaction amount. The method may further include communicating a notification to a mobile device associated with the user, the mobile device includes at least one software application configured to initiate the second transaction using the user account. The payment transaction may be initiated solely using cash. The user account corresponding to the identifier may not be a credit account. The remote system may include a transaction processing system. The method may include communicating a settlement message to an acquirer system, the settlement message configured to cause the acquirer system to initiate a fund transfer for the amount of change due from an account associated with the merchant to the user account corresponding to the identifier. The at least a portion of the amount of change due credited to the user account corresponding to the identifier may be available in real-time for application toward the second transaction amount.

According to a non-limiting embodiment or aspect, provided is a system for processing a transaction initiated using cash, including at least one processor programmed or configured to: determine a transaction amount associated with a payment transaction between a user and a merchant; determine an amount of cash received from the user associated with the payment transaction; in response determining that the amount of cash received exceeds the transaction amount, determine an amount of change due to the user; receive an identifier associated with the user; in response to determining the amount of change due, generate a credit message identifying the amount of change due and the identifier; and communicate the credit message to a remote system configured to credit the amount of change due to a user account corresponding to the identifier.

In one non-limiting embodiment or aspect, the processor may further be programmed or configured to: in response to the user initiating a second payment transaction having a second transaction amount, apply at least a portion of the amount of change due credited to the user account corresponding to the identifier toward the second transaction amount. The at least one processor may be further programmed or configured to: communicate a notification to a mobile device associated with the user, the mobile device including at least one software application configured to initiate the second transaction using the user account. The payment transaction may be initiated solely using cash. The user account corresponding to the identifier may not be a credit account. The at least one processor may be further programmed or configured to: communicate a settlement message to an acquirer system, the settlement message configured to cause the acquirer system to initiate a fund transfer for the amount of change due from an account associated with the merchant to the user account corresponding to the identifier.

According to a non-limiting embodiment or aspect, provided is a computer program product for processing a transaction initiated using cash, the computer program product including at least one non-transitory computer-readable medium including one or more instructions that, when executed by at least one processor, cause the at least one processor to: determine a transaction amount associated with a payment transaction between a user and a merchant; determine an amount of cash received from the user associated with the payment transaction; in response determining that the amount of cash received exceeds the transaction amount, determine an amount of change due to the user; receive an identifier associated with the user; in response to determining the amount of change due, generate a credit message identifying the amount of change due and the identifier; and communicate the credit message to a remote system configured to credit the amount of change due to a user account corresponding to the identifier.

In one non-limiting embodiment or aspect, the one or more instructions may cause the at least one processor to: in response to the user initiating a second payment transaction having a second transaction amount, apply at least a portion of the amount of change due credited to the user account corresponding to the identifier toward the second transaction amount. The one or more instructions may cause the at least one processor to: communicate a notification to a mobile device associated with the user, the mobile device including at least one software application configured to initiate the second transaction using the user account. The payment transaction may be initiated solely using cash. The user account corresponding to the identifier may not be a credit account. The one or more instructions may cause the at least one processor to: communicate a settlement message to an acquirer system, the settlement message configured to cause the acquirer system to initiate a fund transfer for the amount of change due from an account associated with the merchant to the user account corresponding to the identifier.

Further embodiments or aspects are set forth in the following numbered clauses:

Clause 1: A computer-implemented method for processing a transaction initiated using cash comprising: determining, with at least one processor of a merchant system, a transaction amount associated with a payment transaction between a user and a merchant; determining, with the at least one processor, an amount of cash received from the user associated with the payment transaction; in response determining that the amount of cash received exceeds the transaction amount, determining, with the at least one processor, an amount of change due to the user; receiving, with the at least one processor, an identifier associated with the user; in response to determining the amount of change due, generating, with the at least one processor, a credit message identifying the amount of change due and the identifier; and communicating, with the at least one processor, the credit message to a remote system configured to credit the amount of change due to a user account corresponding to the identifier.

Clause 2: The computer-implemented method of clause 1, wherein, in response to the user initiating a second payment transaction having a second transaction amount, applying, with at least one processor, at least a portion of the amount of change due credited to the user account corresponding to the identifier toward the second transaction amount.

Clause 3: The computer-implemented method of clause 1 or 2, further comprising communicating a notification to a mobile device associated with the user, the mobile device comprising at least one software application configured to initiate the second transaction using the user account.

Clause 4: The computer-implemented method of any of clauses 1-3, wherein the payment transaction is initiated solely using cash.

Clause 5: The computer-implemented method of any of clauses 1-4, wherein the user account corresponding to the identifier is not a credit account.

Clause 6: The computer-implemented method of any of clauses 1-5, wherein the remote system comprises a transaction processing system.

Clause 7: The computer-implemented method of any of clauses 1-6, further comprising communicating a settlement message to an acquirer system, the settlement message configured to cause the acquirer system to initiate a fund transfer for the amount of change due from an account associated with the merchant to the user account corresponding to the identifier.

Clause 8: The computer-implemented method of any of clauses 1-7, wherein the at least a portion of the amount of change due credited to the user account corresponding to the identifier is available in real-time for application toward the second transaction amount.

Clause 9: A system for processing a transaction initiated using cash, comprising at least one processor programmed or configured to: determine a transaction amount associated with a payment transaction between a user and a merchant; determine an amount of cash received from the user associated with the payment transaction; in response determining that the amount of cash received exceeds the transaction amount, determine an amount of change due to the user; receive an identifier associated with the user; in response to determining the amount of change due, generate a credit message identifying the amount of change due and the identifier; and communicate the credit message to a remote system configured to credit the amount of change due to a user account corresponding to the identifier.

Clause 10: The system of clause 9, wherein the at least one processor is further programmed or configured to: in response to the user initiating a second payment transaction having a second transaction amount, apply at least a portion of the amount of change due credited to the user account corresponding to the identifier toward the second transaction amount.

Clause 11: The system of clause 9 or 10, wherein the at least one processor is further programmed or configured to: communicate a notification to a mobile device associated with the user, the mobile device comprising at least one software application configured to initiate the second transaction using the user account.

Clause 12: The system of any of clauses 9-11, wherein the payment transaction is initiated solely using cash.

Clause 13: The system of any of clauses 9-12, wherein the user account corresponding to the identifier is not a credit account.

Clause 14: The system of any of clauses 9-13, wherein the at least one processor is further programmed or configured to: communicate a settlement message to an acquirer system, the settlement message configured to cause the acquirer system to initiate a fund transfer for the amount of change due from an account associated with the merchant to the user account corresponding to the identifier.

Clause 15: The system of any of clauses 9-14, wherein the remote system comprises a transaction processing system.

Clause 16: The system of any of clauses 9-15, wherein the at least a portion of the amount of change due credited to the user account corresponding to the identifier is available in real-time for application toward the second transaction amount.

Clause 17: A computer program product for processing a transaction initiated using cash, the computer program product comprising at least one non-transitory computer-readable medium including one or more instructions that, when executed by at least one processor, cause the at least one processor to: determine a transaction amount associated with a payment transaction between a user and a merchant; determine an amount of cash received from the user associated with the payment transaction; in response determining that the amount of cash received exceeds the transaction amount, determine an amount of change due to the user; receive an identifier associated with the user; in response to determining the amount of change due, generate a credit message identifying the amount of change due and the identifier; and communicate the credit message to a remote system configured to credit the amount of change due to a user account corresponding to the identifier.

Clause 18: The computer program product of clause 17, wherein the one or more instructions cause the at least one processor to: in response to the user initiating a second payment transaction having a second transaction amount, apply at least a portion of the amount of change due credited to the user account corresponding to the identifier toward the second transaction amount.

Clause 19: The computer program product of clause 17 or 18, wherein the one or more instructions cause the at least one processor to: communicate a notification to a mobile device associated with the user, the mobile device comprising at least one software application configured to initiate the second transaction using the user account.

Clause 20: The computer program product of any of clauses 17-19, wherein the payment transaction is initiated solely using cash.

Clause 21: The computer program product of any of clauses 17-20, wherein the user account corresponding to the identifier is not a credit account.

Clause 22: The computer program product of any of clauses 17-21, wherein the one or more instructions cause the at least one processor to: communicate a settlement message to an acquirer system, the settlement message configured to cause the acquirer system to initiate a fund transfer for the amount of change due from an account associated with the merchant to the user account corresponding to the identifier.

Clause 23: The computer program product of any of clauses 17-22, wherein the remote system comprises a transaction processing system.

Clause 24: The computer program product of any of clauses 17-23, wherein the at least a portion of the amount of change due credited to the user account corresponding to the identifier is available in real-time for application toward the second transaction amount.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1A is a schematic view of an existing system for processing a cash-initiated payment transaction;

FIG. 1B is a schematic view of an existing system for processing a credit and/or debit card-initiated payment transaction;

FIG. 2 is a schematic view of one non-limiting embodiment or aspect of a system for processing a transaction initiated using cash according to principles of the present invention;

FIG. 3 is a table showing merchants associated with various acquirer institutions;

FIG. 4 is a process flow diagram of a non-limiting embodiment or aspect of a method for processing a transaction initiated using cash during an initial cash-based transaction initiated by a user according to principles of the present invention;

FIG. 5 is a process flow diagram of a non-limiting embodiment or aspect of a method for processing a subsequent transaction after the initial cash-based transaction processed according to FIG. 4 according to principles of the present inventions;

FIG. 6 is a schematic view of a non-limiting embodiment or aspect of a system for settling a transaction initiated using cash in which a remote ledger system communicates with at least one acquirer system to settle the transaction according to principles of the present invention;

FIG. 7 shows a schematic view of a non-limiting embodiment or aspect of a user interface displaying a ledger history of a user according to principles of the present invention; and

FIG. 8 is a step diagram of one non-limiting embodiment or aspect of a method for processing a transaction initiated using cash according to principles of the present invention.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “issuer institution” or “issuer” may refer to one or more entities, such as a bank, that provide accounts (e.g., credit accounts) to customers for conducting transactions (e.g., payment transactions), such as initiating credit and/or debit payments. For example, an issuer institution may provide an account identifier, such as a personal account number (PAN), to a customer that uniquely identifies one or more accounts associated with that customer. The account identifier may be embodied on a payment device, such as a physical financial instrument, e.g., a payment card, and/or may be electronic and used for electronic payments. The term “issuer system” refers to one or more computer systems operated by or on behalf of an issuer institution, such as a server computer executing one or more software applications. For example, an issuer system may include one or more authorization servers for authorizing a transaction.

As used herein, the term “acquirer institution” or “acquirer” or “merchant bank” may refer to an entity licensed and/or approved by the transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments, an acquirer institution may be a financial institution, such as a bank. As used herein, the term “acquirer system” may refer to one or more computer systems, computer devices, software applications, and/or the like operated by or on behalf of an acquirer institution.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. In other non-limiting embodiments, the computing device may be a desktop computer or other non-mobile computer. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “payment device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the payment device may include volatile or non-volatile memory to store information (e.g., an account identifier, a name of the account holder, and/or the like).

As used herein, the term “biometric input” may refer to any type of biometric provided by a user such as, but not limited to, one or more of the following: a fingerprint, a retinal image, an iris image, a facial image, a hand geometry image, a verbal statement or response, a physiologic indicator, a DNA sample, a signature, and/or the like. The term “biometric input device,” as used herein, may refer to one or more devices and/or systems for receiving and/or providing a biometric input. As an example, a biometric input device may include one or more of the following: a fingerprint scanner, a retina and/or iris scanner, a camera, a microphone, a sensor, a touchscreen, and/or the like.

As used herein, the term “account identifier” may include one or more identifiers associated with an account established for a user. The identifier may include anything that identifies an account as being associated with the user. Non-limiting examples of account identifiers include: a phone number, a social security number, a biometric input, a PAN, a token, and the like. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “server” may refer to or include one or more processors or computers, storage devices, or similar computer arrangements that are operated by or facilitate communication and processing for multiple parties in a network environment, such as the internet, although it will be appreciated that communication may be facilitated over one or more public or private network environments and that various other arrangements are possible. Further, multiple computers, e.g., servers, or other computerized devices, e.g., point-of-sale (POS) devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present invention are directed to a computer-implemented method, system, and computer program product for processing a transaction initiated using cash. Non-limiting embodiments allow for merchants to accept cash payments without requiring them to dispense change to the user in order to complete the transaction. Non-limiting embodiments utilize a unique arrangement of a remote ledger system that enables change due to users from a cash-based transaction to be recorded in a ledger database, such that that change due may be used by the user in subsequent transactions. The ledger database associates the change due to the user with the user by establishing an account for the user, which is not a traditional credit account. Non-limiting embodiments allow the remote ledger system to communicate with various acquirer systems during subsequent transactions in order for the user to use the funds associated with him or her that were processed through the remote ledger system. Non-limiting embodiments utilize a unique and non-conventional arrangement of components, including a remote ledger system in communication with various merchant systems and acquirer systems, such that a user initiating a cash-based transaction may have the change resulting from the transaction credited for use in future transactions without change being physically dispensed to the user. The system and process flow associated with non-limiting embodiments is different from existing cash and debit or credit card initiated transactions.

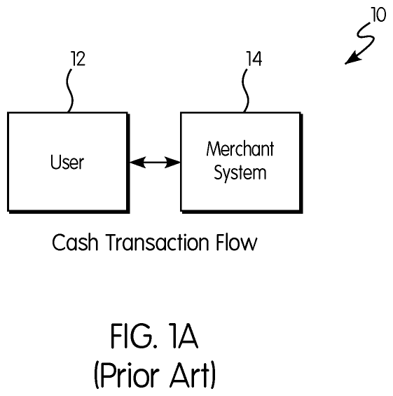

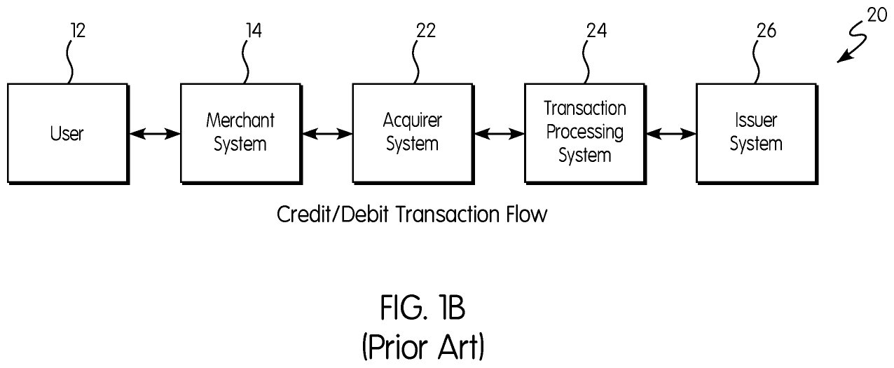

Referring to FIG. 1A, a system 10 for processing payment transactions initiated using cash is shown. In this system 10, a user/user device 12 (hereinafter “user”) initiates a payment transaction with a merchant in exchange for goods and/or services of the merchant by presenting cash to the merchant (e.g., a merchant system 14 (e.g., a merchant POS)). In the case that the user 12 presents cash exceeding the amount of the purchase (e.g., does not present exact change) to the merchant system 14, the merchant system 14 gives the user 12 change in the amount equal to the value of cash exceeding the amount of the purchase. This change is in the form of cash. In order for the payment transaction to be initiated based on the system 10 shown in FIG. 1A, the merchant is required to accept cash-initiated transactions, which, over time, is becoming a less accepted form of payment by merchants.

Referring to FIG. 1B, a system 20 for processing payment transactions initiated using a payment device (e.g., a credit card) is shown. In this system 20, a user 12 initiates a payment transaction with a merchant in exchange for goods and/or services of the merchant using a payment device issued to the user 12. Upon the user 12 initiating the payment transaction with the merchant system 14, the merchant system 14 communicates a transaction message to an acquirer system 22 operated by or on behalf of an acquirer (e.g., a merchant bank). The acquirer may be the acquirer of the merchant, and the transaction message may be communicated to the acquirer system 22 in order to request processing of the payment transaction. The transaction message may include data required for an authorization decision (e.g., approve or decline), such as account identifying information, transaction data, and/or the like. Such information may include the data elements identified in ISO 8583, as an example.

With continued reference to FIG. 1B, the acquirer system 22 may communicate the transaction message to a transaction processing system 24 operated by or on behalf of a transaction service provider. The transaction service provider may be the transaction service provider associated with the payment device used by the user 12 to initiate the payment transaction. The transaction processing system 24 may communicate an authorization request to an issuer system 26 operated by or on behalf of an issuer. The issuer may be the issuer of the payment device used by the user to initiate the payment transaction. The authorization request may be based on the transaction message and may be communicated to the issuer system 26 in order to request an authorization decision from the issuer system 26. The authorization request may be structured and communicated from the transaction processing system 24 to the issuer system 26 pursuant to ISO 8583 or any other standard protocol for authorization requests.

With continued reference to FIG. 1B, in response to receiving the authorization request, the issuer system 26 may generate an authorization decision for the payment transaction. The authorization decision may be to approve the transaction, decline the transaction, approve the transaction in part, decline the transaction in part, or some combination thereof. The issuer system 26 may communicate the authorization decision to the transaction processing system 24. The authorization decision may be structured and communicated from the issuer system 26 to the transaction processing system 24 pursuant to ISO 8583 or any other standard protocol for authorization decisions.

With continued reference to FIG. 1B, the transaction processing system 24 may communicate a transaction response to the acquirer system 22, and the transaction response may include the authorization decision. The acquirer system 22 may communicate the transaction response to the merchant system 14 which, in turn, communicates the transaction response to the user 12. This system 20 for processing payment transactions initiated using a payment device requires the user to have an accepted payment device issued to the user 12 from an issuer. Not all users may have sufficient creditworthiness for an issuer to issue a payment device to the user 12.

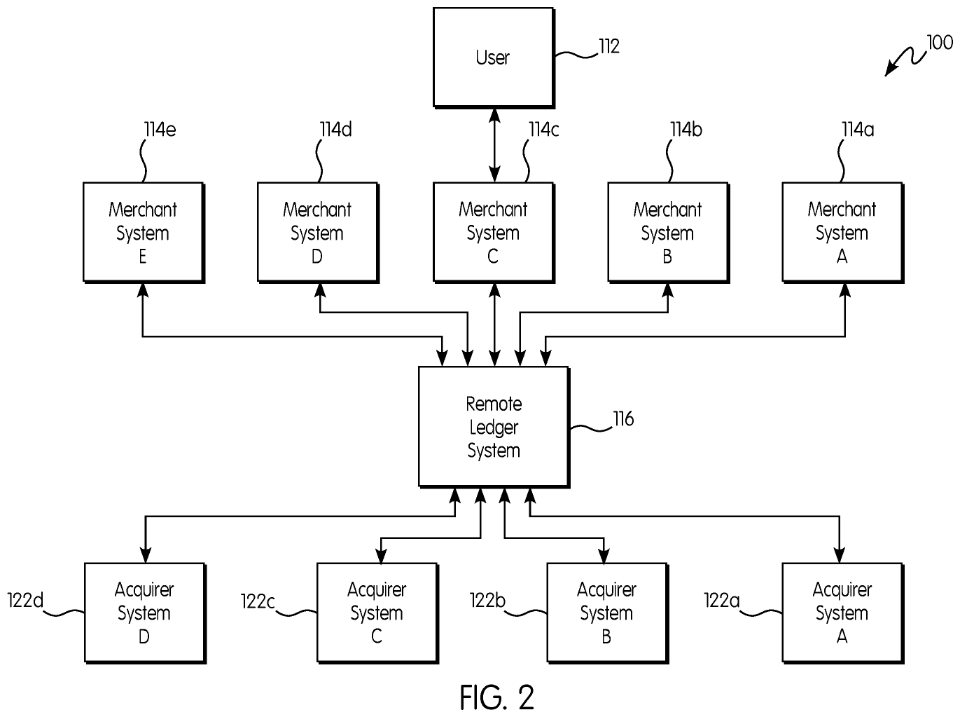

Referring to FIG. 2, a system 100 for processing a payment transaction initiated using cash according to non-limiting embodiments or aspects is shown. In this system 100, the user 112 may initiate a payment transaction with a merchant in exchange for goods and/or services of the merchant by presenting cash to the merchant system 114a-114e (merchant system 114c in the illustrated embodiment). In the case that the user 112 presents cash exceeding the amount of the purchase (e.g., does not present exact change) to the merchant system 114c, the payment transaction is processed using the system 100. Moreover, the user 112 is not required to have an existing account (e.g., credit account) in order to process the payment transaction using the illustrated system 100.

With continued reference to FIG. 2, to process the payment transaction initiated using cash according to non-limiting embodiments, the merchant system 114c may communicate with a remote ledger system 116 (RLS). The RLS 116 may be arranged remotely from the merchant systems 114a-114e. The RLS 116 may be operated by or on behalf of a transaction service provider, an issuer, or other third party payment facilitating entity. The RLS 116 may refer to one or more computer systems, such as a remote ledger server executing one or more software applications. The RLS 116 may include one or more processors. In some non-limiting embodiments or aspects, the RLS 116 may be part of a transaction processing system as previously described. In some non-limiting embodiments or aspects, the RLS 116 may be part of an issuer system as previously described.

With continued reference to FIG. 2, the RLS 116 may communicate with acquirer systems 122a-122d in order to process the payment transaction initiated using cash. Each acquirer system 122a-122d may be associated with at least one of the merchant systems 114a-114e in the system 100. In this way, each acquirer system 122a-122d may be the merchant bank for at least one of the merchant systems 114a-114e in the system 100.

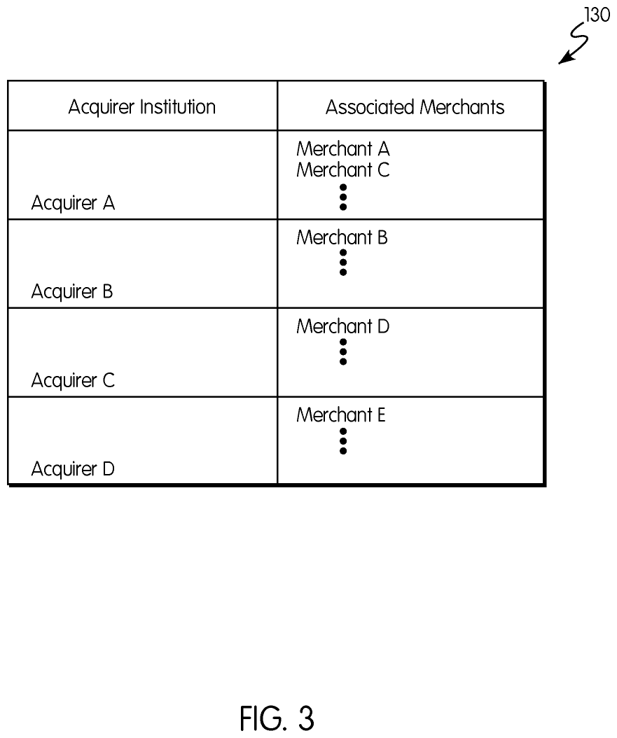

Referring to FIGS. 2 and 3, a table 130 shows a non-limiting example of various acquirers in the system 100 associated with corresponding merchants. In this example, Acquirer A is the merchant bank for Merchants A and C. Acquirer B is the merchant bank for Merchant B. Acquirer C is the merchant bank for Merchant D. Acquirer D is the merchant bank for Merchant E. The system 100 may include any number and arrangement of merchants and acquirers.

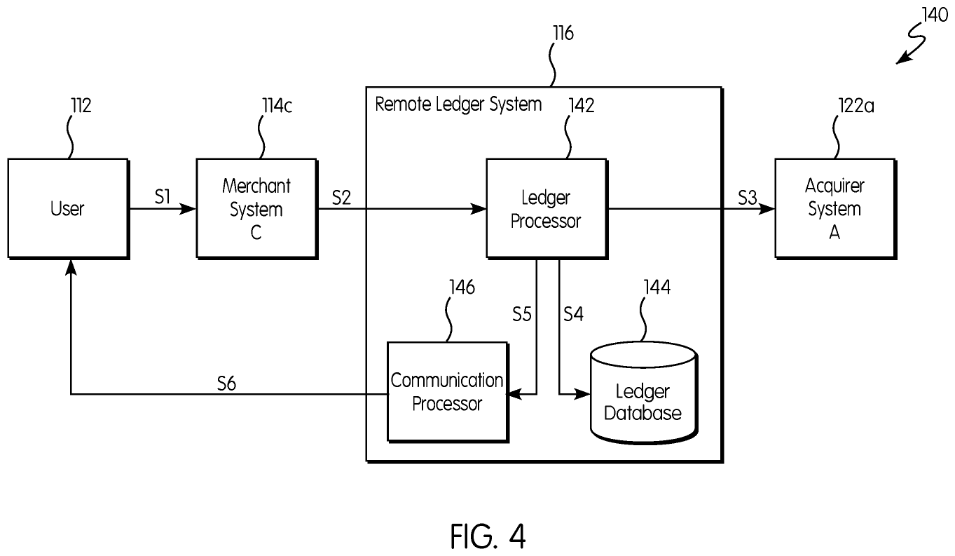

Referring to FIG. 4, a non-limiting embodiment or aspect of a process 140 for processing a transaction initiated using cash during an initial cash-based transaction initiated by a user is shown. At a first step S1, merchant system 114c may determine a transaction amount associated with a payment transaction between the user 112 and the merchant. In response, the user 112 may initiate processing of the payment transaction by presenting cash to the merchant system 114c. This payment transaction may be initiated solely using cash, without including any other payment method. The user 112 presents an amount of cash exceeding the required payment amount to the merchant system 114c.

At a second step S2, the merchant system 114c may determine an amount of cash received from the user 112 and may determine that the amount of cash received exceeds the required payment amount. In response to determining that the amount of cash received from the user exceeds the required payment amount, the merchant system 114c may determine an amount of change due to the user 112. The merchant system 114c may also receive an identifier associated with the user 112. The identifier may include anything that may be used to identify an account as being associated with the user. Non-limiting examples of identifiers include: a phone number, a social security number, a biometric input, a PAN, a token, and/or the like. For the non-limiting embodiments described hereinafter, the identifier will be discussed as being a phone number of the user, but any other type of identifier may be used. In response to determining the amount of change due and receiving the identifier, the merchant system 114c may generate a credit message and communicate that credit message to the RLS 116. The credit message may include the amount of change due for the payment transaction. The credit message may include the identifier associated with the user 112. The credit message may also include user data associated with the user, such as name, contact information, date of birth, social security number, biometric information, and/or the like. The credit message may include account security information to be associated with an RLS account described hereinafter, such as a user name, password, biometric information, security question, account identifier, and/or the like. The credit message may include transaction information, such as goods and/or service purchased, UPC codes, purchase price, payment amount, and/or the like.

With continued reference to FIG. 4, and as previously discussed, the RLS 116 may receive the credit message. The RLS 116 may include a ledger processor 142 configured to process credit messages received by the merchant systems 114a-e. The RLS 116 may further include a ledger database 144, which may store information associated with RLS accounts of users. RLS accounts may be accounts set up by the RLS 116 for users initiating payment transactions using cash at various merchants, and the RLS accounts may track the amount of funds due to a user 112 from the payment transactions so as to keep record of the amount of funds from change due to the user 112. During subsequent payment transactions, the user 112 may invoke the system in order to use the amount of funds due to the user 112 according to the RLS account records. The ledger database 144 may store the records of the amount of change due to the users and may also store account information associate with the users, which may be associated with the amount of change due to the users. The ledger database 144 may communicate with the ledger processor 142.

The RLS 116 may further include a communication processor 146. The communication processor 146 may be the same processor as the ledger processor 142 or may be a different processor in communication with the ledger processor 142. The communication processor 146 may communicate with the user 112, such as a computing device thereof, and may communicate messages to the user 112 regarding transactions initiated by the user using 112 this system. In some non-limiting examples, the communication processor 146 may communicate messages to the user 112 via a mobile application on the mobile device of the user. In some non-limiting embodiments, the communication processor 146 may communicate with the user 112 by sending an SMS text message or other message to the user's mobile device. The communication processor 146 may communicate with the user 112 via email, phone call, or by any other communication means.

With continued reference to FIG. 4 and the second step S2 thereof, the RLS 116, upon receiving the credit message, may determine whether the user 112 has an existing RLS account. The ledger processor 142 of the RLS 116 may determine whether the user has an RLS account based on the credit message. The ledger processor 142 may communicate with the ledger database 144 to determine whether the user 112 has an RLS account. Upon determining that the user 112 does not have an existing RLS account, the ledger processor 142 may generate and issue an RLS account for the user 112. The ledger processor 142 may communicate with the user 112 and/or the merchant system 114c to collect additional information required to issue an RLS account to the user. Information associated with this issued RLS account of the user may be communicated to and stored in the ledger database 144. The RLS accounts issued to various users are not credit accounts, as no line of credit is extended to the users from these RLS accounts. Instead, these RLS accounts may include a record of the amount of funds (e.g., from change) due to the users initiating cash-based transactions and allow the user to use up to that amount to pay for subsequent transactions.

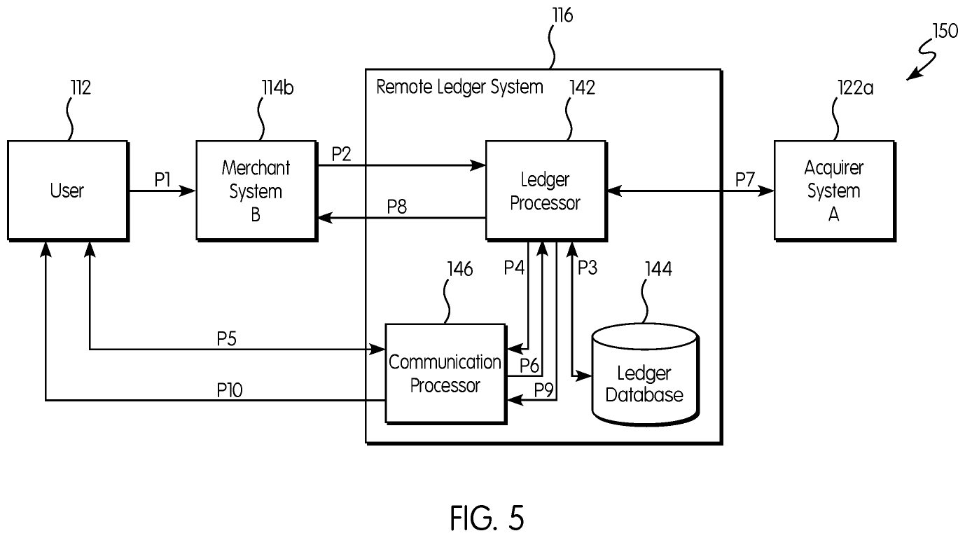

With continued reference to FIG. 4, at a third step S3, the RLS 116 (e.g., the ledger processor 142 thereof) may communicate with the acquirer system 122a associated with the merchant system 114c (Acquirer A is the merchant bank of Merchant C). The ledger processor 142 may communicate with the acquirer system 122a so that the acquirer system 122a may authorize the amount of change due to the user 112. In some non-limiting embodiments, the amount of change due to the user 112 remains with the acquirer system 122a (since no change is dispensed to the user 112 in this system). Therefore, the acquirer system 122a retains an amount of funds over the transaction amount (the change due) and may be required to provide that amount of change due for use in a subsequent payment transaction initiated by the user 112 at the same or different merchant, which will be described hereinafter in FIG. 5. In other non-limiting embodiments, the acquirer system 122a does not retain the amount of change due and, instead, transfers the amount of change due to the RLS 116, which retains the amount of change due to the user 112, which may be used by the user 112 in subsequent transactions. In such embodiments, the acquirer system 122a may initiate a fund transfer for the amount of funds due (e.g., change due) to the RLS 16 to be associated with the user's RLS account. It will be appreciated that the merchant may also be the entity retaining the amount of change due to the user 112, for use by the user 112 in subsequent payment transactions.

With continued reference to FIG. 4, at a fourth step S4, the ledger processor 142 may communicate with the ledger database 144 to record the amount of change due to the user, such that the ledger database 144 includes an accurate record of the amount of funds available to the user 112 for use in subsequent payment transactions. The ledger database 144 may also record an identifier of an acquirer system 122a-122d, an identifier of a merchant system 114a-114e, and/or an indication of whether the RLS 116 retained the change due to the user 112. In this way, the ledger database 144 may include information regarding how much available funds are associated with the user's RLS account and where the funds are to be pulled from (e.g., which entity or entities retained those funds) to settle subsequent payment transactions.

At a fifth step S5, the ledger processor 142 may communicate data associated with the payment transaction to the communication processor 146. At a sixth step S6, the communication processor 146 may communicate a notification message to the user 112 (e.g., to a mobile device thereof) that includes data associated with the payment transaction. Such data may include a notification that the payment transaction has been processed and approved. The notification message may include an amount of funds available to the user 112 associated with his/her RLS account for use in subsequent transactions.

The process 140 illustrated in FIG. 4 may also apply in a scenario in which the user 112 has reached a zero balance according to the ledger database 144 in an existing RLS account, even if the transaction is not the first payment transaction initiated by the user with cash based on the present system 100 shown in FIG. 2. However, since the RLS account is already issued for the user 112, no new account needs to be issued for the user. Rather, additional funds may be associated with his/her existing RLS account.

Referring to FIG. 5, a non-limiting embodiment or aspect of a process 150 for processing a subsequent transaction after the initial cash-based transaction processed according to FIG. 4 is shown. In this way, the user 112 has an RLS account associated with some amount of available funds to use towards subsequent transactions and an identifier associated with that RLS account.

At a first step P1, the user 112 may initiate a subsequent transaction associated with a second transaction amount with a merchant system 114b operated by or on behalf of Merchant B. In this non-limiting embodiment, the merchant is different from the merchant from the transaction described in association with FIG. 4 (e.g., not Merchant C), but it will be appreciated that the merchant in this subsequent transaction may be the same merchant as in the initial transaction. The user 112 may initiate the subsequent transaction by communicating with the merchant system 114b to request that at least a portion of the funds associated with the user's RLS account be used toward the second transaction amount. The user 112 may initiate the subsequent transaction using his/her computing device (e.g., a mobile phone), such as by using a mobile application or website associated with the system to initiate the subsequent transaction. Access to the mobile application and/or website for initiating subsequent transactions and/or viewing information associated with the user's RLS account may be protected by a username, password, biometric input, and/or other secure means so that another user may not fraudulently obtain access to the user's RLS account. In other non-limiting embodiments, the user 112 may request that the merchant system 114b initiate the payment transaction, such that the funds associated with the user's RLS account may be used towards the second transaction amount. The user 112 may provide his/her identifier (e.g., phone number) associated with the RLS account during initiation of the transaction.

With continued reference to FIG. 5, at a second step P2, the merchant system 114b may communicate a second credit message to the RLS system 116 (e.g., the ledger processor 142 thereof). The ledger processor 142 may determine that the user 112 has an existing RLS account based on the second credit message. The ledger processor 142 may communicate with the ledger database 144 to determine that the user 112 has an existing RLS account.

With continued reference to FIG. 5, at a third step P3, the ledger processor 142 may communicate with the ledger database 144 to determine the amount of funds available for use by the user 112 in the subsequent payment transaction. This amount of funds available for use may have been accumulated by the user from previous transactions initiated by the user 112 using cash, which were processed according to the system described herein. These funds may be available in real time after the prior payment transaction initiated using cash has been processed, for application toward the second transaction amount. In response to determining the amount of funds available for use by the user in the subsequent payment transaction, the ledger database may update the record accordingly to reflect the new amount of funds available to the user 112 associated with the RLS account after applying funds to the second transaction amount. If the user has more funds associated with the RLS account than the second transaction amount, the RLS account has remaining funds associated with the RLS account for use in subsequent payment transactions. If the user does not have enough funds associated with the RLS account to cover the entire second transaction amount, the user 112 may apply all or part of the funds associated with the RLS account toward the second transaction amount and use a different payment method to cover the remainder of the second transaction amount.

With continued reference to FIG. 5 and the third step S3, upon determining the amount of funds available for use associated with the RLS account, the ledger database 144 may further determine the entity or entities retaining the funds of the user 112 from previous transactions. In this particular non-limiting example, the acquirer system 122a of Acquirer A retained the funds from the process in FIG. 4 because Acquirer A is the merchant bank of Merchant C (the merchant from the initial transaction). In some non-limiting examples, multiple entities (e.g., multiple acquirers) may retain at least a portion of the user's available funds associated with the RLS account. In some non-limiting examples, and as previously mentioned, the RLS 116 may retain all of the user's funds available and associated with the RLS account by receiving a fund transfer from the acquirer system during processing of the initial payment transaction.

Upon determining the amount of funds associated with the RLS account to be used, updating the record associated with the RLS account to reflect the new amount of funds remaining, and determining the entity or entities retaining the funds, the ledger database 144 may communicate a response to the ledger processor 142 with at least a portion of this information. At a fourth step P4, the ledger processor 142 may communicate with the communication processor 146 to cause the communication processor 146 to communicate an approval request to the user 112. At a fifth step P5, the communication processor 146 may communicate the approval request to the user 112 to request that the user 112 approve use of the funds available and associated with the user's RLS account. The approval request may include the amount of funds being used associated with the user's RLS account, the amount of funds remaining and associated with the user's RLS account, or any other relevant information. The user 112 may communicate an approval response to the communication processor 146 with a decision as to whether to use all or part of the funds associated with the RLS account. The user 112 may change the amount of funds to be used that are associated with the RLS account, such as requesting that a smaller amount of funds associated with the RLS account be used for the subsequent payment transaction. The user 112 may also decline to use the funds associated with the RLS account for the subsequent payment transaction and elect to keep that amount associated with the RLS account for future use. At a sixth step, P6, the communication processor 146 may communicate the approval response to the ledger processor 142.

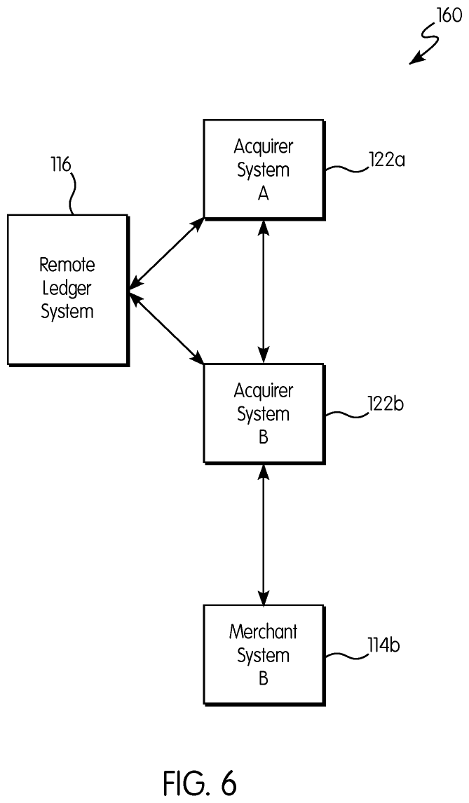

With continued reference to FIG. 5, at a seventh step P7, upon receiving instructions from the user 112 through the approval response that at least a portion of the funds associated with the RLS account are to be applied to the second transaction amount, the ledger processor 142 may communicate a settlement message to the acquirer system 122a. The settlement message may be configured to cause the acquirer system 122a to initiate a fund transfer for the amount of funds to be used that are associated with the RLS account. An example of this fund transfer is shown in further detail in FIG. 6, described hereinafter. The settlement message may notify the acquirer system 122a of the amount of funds retained by the acquirer system 122a and to be used towards the second transaction amount so that the acquirer system 122a may place a hold for the amount of funds to be used. The acquirer system 122a may communicate a response to the ledger processor 142 that the amount of funds is on hold, ready to be transferred, and/or has been successfully transferred.

With continued reference to FIG. 5, at an eighth step P8, the ledger processor 142 may communicate a notification message to the merchant system 114b that the subsequent payment transaction has been approved using at least a portion of the funds associated with the user's RLS account. The notification message may further communicate an indication of whether any portion of the second transaction amount was not covered by the amount associated with the user's RLS account (e.g., due to the second transaction amount exceeding the funds associated with the user's RLS account). In this scenario, the merchant system 114b may prompt the user 112 to present a subsequent form of payment to cover the remainder of the second transaction amount.

At a ninth step P9, the ledger processor 142 may communicate to the communication processor 146 that the subsequent payment transaction has been successfully processed and the funds associated with the user's RLS account applied. At a tenth step P10, the communication processor 146 may communicate a completion message to the user 112 notifying the user that the subsequent payment transaction has been successfully processed and the funds associated with the user's RLS account applied. The completion message may further include a balance of funds remaining and associated with the user's RLS account and an amount of funds associated with the RLS account that was applied in the subsequent payment transaction.

Referring to FIG. 6, a system 160 for settling a transaction (as described in connection with FIG. 5) initiated using cash is shown according to a non-limiting embodiment. As described in connection with FIGS. 4 and 5, in one non-limiting embodiment or aspect, the user 112 initiated an initial payment transaction with merchant system C 114c (operated by or on behalf of Merchant C), and the change from that transaction was retained by acquirer system A 122a and credited to be associated with the user's RLS account (recorded in the ledger database 144) as funds to be applied to a subsequent payment transaction. Then, the user initiated a subsequent payment transaction with merchant system B 114b (operated by or on behalf of Merchant B), where acquirer system B 122b is the system associated with the merchant bank (Acquirer B) of Merchant B. In this subsequent payment transaction, the user 112 requested to use funds associated with his/her RLS account toward the second transaction amount. Since acquirer system A 122a retained these funds from the initial payment transaction, at a seventh step P7 from the process 150 shown in FIG. 5, the RLS 116 communicated a settlement message to acquirer system A 122a, which placed a hold for the amount.

With continued reference to FIG. 6, in order to settle the subsequent payment transaction, acquirer system A 122a may transfer funds to acquirer system B 122b for the amount of funds associated with the RLS account used toward the second transaction amount because Acquirer B is the merchant bank of Merchant B, which is the merchant involved in the second payment transaction. In some non-limiting embodiments, the funds may be transferred directly from acquirer system A 122a to acquirer system B 122b without passing through an intermediary entity. Acquirer system B 122b may communicate with the RLS 116 upon receipt of the transferred amount, such that the RLS 116 can record that the transfer has been completed and that acquirer system A 122a no longer retains funds in the amount associated with the user's RLS account. In some non-limiting embodiments, this transfer of funds may be transferred indirectly from acquirer system A 122a to acquirer system B 122b by passing through an intermediary entity. For example, the intermediary entity may be the RLS 116. In response to acquirer system B 122b receiving the fund transfer, acquirer system B 122b may transfer at least a portion of the amount to merchant system B 114b. In a case in which the RLS 116 retains the funds associated with the user's RLS account, the RLS 116 may transfer the funds to the correct acquirer system.

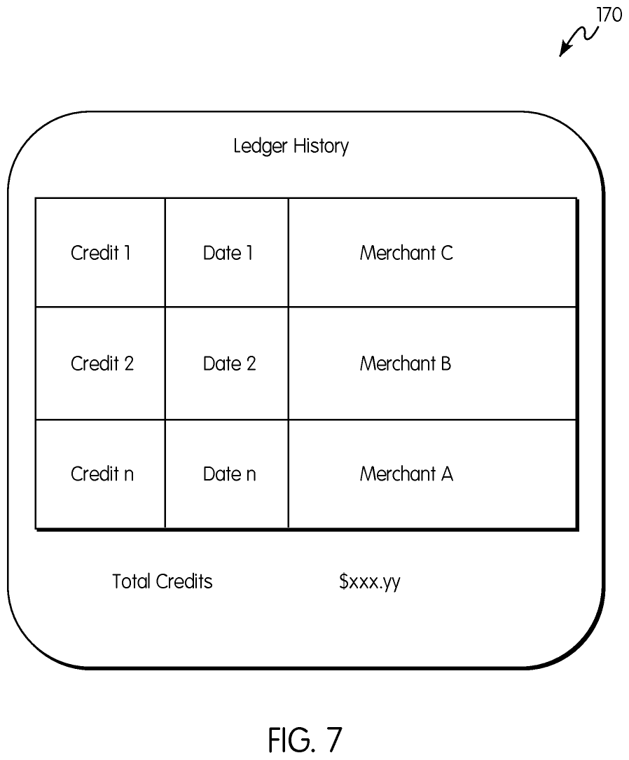

Referring to FIG. 7, the system and process as described above may include a mobile application and/or a website made available to users, merchants, and/or acquirers, in order to facilitate processing of the cash-based transactions initiated by the users. A non-limiting embodiment or aspect of a user interface 170 is shown, which may be a user interface 170 displayed by the mobile application and/or website associated with the system. The user interface 170 may display a ledger history associated with the user, and which the user may review in order to ensure funds were not fraudulently used. The ledger history may include amounts credited to and debited from the funds associated with the user's RLS account, the date of those credits/debits, the merchants associated with the transaction in which the amount was credited or debited, and a total amount of funds available to the user and associated with the RLS account. The ledger history, or other user interfaces associated with an application and/or website of the system, may provide further transaction data, such as an identification of the goods and/or services purchased. In this way, the user may transparently track transactions processed using the system. As previously discussed, the application and/or the website may also be used by the users and/or merchants to initiate payment transactions.

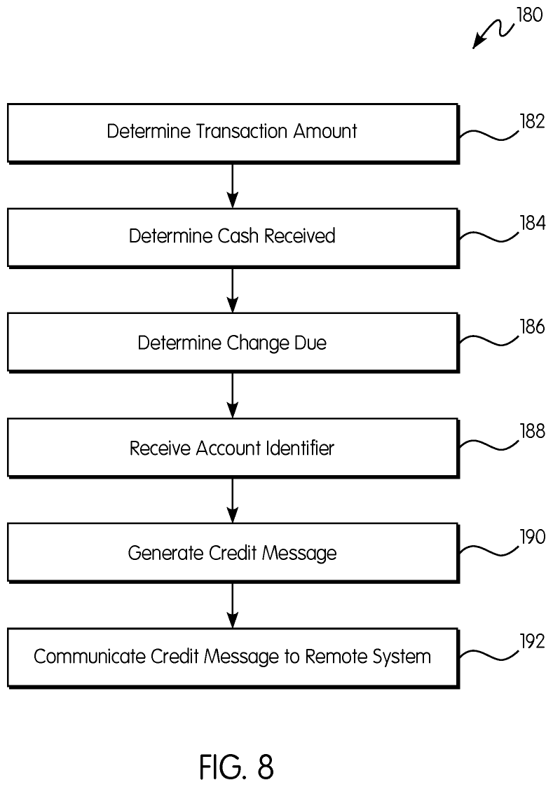

Referring to FIG. 8, a non-limiting embodiment or aspect of a method 180 for processing a transaction initiated using cash is shown. At a first step 182, the merchant system may determine a transaction amount associated with a payment transaction between the user and the merchant. At a second step 184, the merchant system may determine an amount of cash received from the user associated with the payment transaction. At a third step 186, the merchant system may, in response determining that the amount of cash received exceeds the transaction amount, determine an amount of change due to the user. At a fourth step 188, the merchant system may receive an identifier associated with the user. At a fifth step 190, the merchant system may in response to determining the amount of change due, generate a credit message identifying the amount of change due and the identifier. At a sixth step 192, the merchant system may communicate to the RLS the credit message to credit the amount of change due to a user account corresponding to the identifier.

In a further, non-limiting embodiment or aspect, a computer program product for processing a transaction initiated using cash includes at least one non-transitory computer readable medium including program instructions that, when executed by at least one processor, cause the at least one processor to execute any of the methods described herein. The at least one processor may include the merchant system, the RLS, the acquirer system, the transaction processing system, the issuer system, or some combination thereof.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for processing a transaction initiated using cash comprising:
determining, with at least one processor of a merchant system, a transaction amount associated with a payment transaction between a user and a merchant;
determining, with the at least one processor, an amount of cash received from the user associated with the payment transaction;
in response determining that the amount of cash received exceeds the transaction amount, determining, with the at least one processor, an amount of change due to the user;
receiving, with the at least one processor, an identifier associated with the user;
in response to determining the amount of change due, generating, with the at least one processor, a credit message identifying the amount of change due and the identifier; and
communicating, with the at least one processor, the credit message to a remote system configured to credit the amount of change due to a user account corresponding to the identifier.

2. The computer-implemented method of claim 1, wherein, in response to the user initiating a second payment transaction having a second transaction amount, applying, with at least one processor, at least a portion of the amount of change due credited to the user account corresponding to the identifier toward the second transaction amount.

3. The computer-implemented method of claim 2, further comprising communicating a notification to a mobile device associated with the user, the mobile device comprising at least one software application configured to initiate the second transaction using the user account.

4. The computer-implemented method of claim 1, wherein the payment transaction is initiated solely using cash.

5. The computer-implemented method of claim 1, wherein the user account corresponding to the identifier is not a credit account.

6. The computer-implemented method of claim 1, wherein the remote system comprises a transaction processing system.

7. The computer-implemented method of claim 1, further comprising communicating a settlement message to an acquirer system, the settlement message configured to cause the acquirer system to initiate a fund transfer for the amount of change due from an account associated with the merchant to the user account corresponding to the identifier.

8. The computer-implemented method of claim 2, wherein the at least a portion of the amount of change due credited to the user account corresponding to the identifier is available in real-time for application toward the second transaction amount.

9. A system for processing a transaction initiated using cash, comprising at least one processor programmed or configured to:
determine a transaction amount associated with a payment transaction between a user and a merchant;
determine an amount of cash received from the user associated with the payment transaction;
in response determining that the amount of cash received exceeds the transaction amount, determine an amount of change due to the user;
receive an identifier associated with the user;
in response to determining the amount of change due, generate a credit message identifying the amount of change due and the identifier; and
communicate the credit message to a remote system configured to credit the amount of change due to a user account corresponding to the identifier.

10. The system of claim 9, wherein the at least one processor is further programmed or configured to:
in response to the user initiating a second payment transaction having a second transaction amount, apply at least a portion of the amount of change due credited to the user account corresponding to the identifier toward the second transaction amount.

11. The system of claim 10, wherein the at least one processor is further programmed or configured to:
communicate a notification to a mobile device associated with the user, the mobile device comprising at least one software application configured to initiate the second transaction using the user account.

12. The system of claim 9, wherein the payment transaction is initiated solely using cash.

13. The system of claim 9, wherein the user account corresponding to the identifier is not a credit account.

14. The system of claim 9, wherein the at least one processor is further programmed or configured to:
communicate a settlement message to an acquirer system, the settlement message configured to cause the acquirer system to initiate a fund transfer for the amount of change due from an account associated with the merchant to the user account corresponding to the identifier.

15. A computer program product for processing a transaction initiated using cash, the computer program product comprising at least one non-transitory computer-readable medium including one or more instructions that, when executed by at least one processor, cause the at least one processor to:
determine a transaction amount associated with a payment transaction between a user and a merchant;
determine an amount of cash received from the user associated with the payment transaction;
in response determining that the amount of cash received exceeds the transaction amount, determine an amount of change due to the user;
receive an identifier associated with the user;
in response to determining the amount of change due, generate a credit message identifying the amount of change due and the identifier; and
communicate the credit message to a remote system configured to credit the amount of change due to a user account corresponding to the identifier.

16. The computer program product of claim 15, wherein the one or more instructions cause the at least one processor to:
in response to the user initiating a second payment transaction having a second transaction amount, apply at least a portion of the amount of change due credited to the user account corresponding to the identifier toward the second transaction amount.

17. The computer program product of claim 16, wherein the one or more instructions cause the at least one processor to:
communicate a notification to a mobile device associated with the user, the mobile device comprising at least one software application configured to initiate the second transaction using the user account.

18. The computer program product of claim 15, wherein the payment transaction is initiated solely using cash.

19. The computer program product of claim 15, wherein the user account corresponding to the identifier is not a credit account.

20. The computer program product of claim 15, wherein the one or more instructions cause the at least one processor to:
communicate a settlement message to an acquirer system, the settlement message configured to cause the acquirer system to initiate a fund transfer for the amount of change due from an account associated with the merchant to the user account corresponding to the identifier.
